(19) United States
(12) Patent Application Publication
(10) Pub. No.: US 2005/0129182 A1
(43) Pub. Date: Jun. 16, 2005

(54) Method for determining the operating state of a telecommunications newtwork

(75) Inventors: Christian Kanzian, A-Wien (AT); Rolf Laskowsky, Munchen (DE); Ulrich Lieflander, Alling (DE); Franz Schmoller, Germering (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/497,017

(22) PCT Filed: Nov. 27, 2002
(86) PCT No.: PCT/EP02/13352

(30) Foreign Application Priority Data
Nov. 30, 2001 (EP) 01128565.7

(51) Int. Cl. H04M 1/24; H04M 3/08

(52) U.S. Cl. 379/1.01; 379/22

(57) ABSTRACT

The invention relates to a method and an arrangement for determining the operating status of at least one part of a telecommunications network, in particular the operating status of any subscriber connection in a telecommunications network, with which the request for this is made via any telecommunications terminal and the operating status is output in a predeterminable manner to any telecommunications terminal. For example, a subscriber in a telecommunications network can obtain information in this way regarding a malfunction in the telecommunications network.

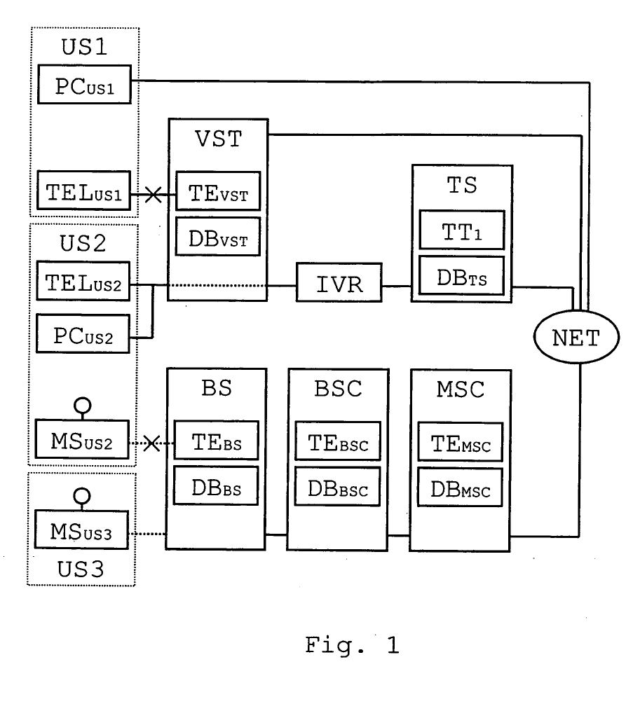

The invention relates to a method for determining the operating status of at least one part of a telecommunications network, in particular the operating status of any subscriber connection in a telecommunications network. The invention also relates to an arrangement for implementing the method.

The large number of subscribers connected to a switching center in a telecommunications network and the wide range of services offered in a telecommunications network mean that there is a comparatively high probability that errors will occur. The major importance of an operational telecommunications network to economic and social spheres of life means that the malfunction of a subscriber connection or the connecting lines in the telecommunications network represents a serious technical problem.

In particular when identifying a malfunction in a telecommunications network it is necessary to determine the current status of said telecommunications network. An analysis of at least one part of the telecommunications network may be initiated for this reason and this may for example comprise the following tests:
test on subscriber connections based on call numbers
group test listing the individual measured values
individual tests of a specific nature.
injection of analog identification tones for line identification.
measuring and storing characteristic line data.
access to a centrally managed database, in which information is stored about past incidents, such as for example the number of malfunctions, the duration and time/date of the malfunction, as well as the operator responsible for rectifying a malfunction and the resulting cost in respect of time and materials. Also data about relative availability or downtime is managed in this database.
contact with the subscriber for the purposes of eliminating errors.

Malfunction is frequently identified by the user of a defective subscriber connection, who reports this to the operator of the telecommunications network. Call centers are frequently set up for this purpose, whereby the operators working there work with the people reporting an error to carry out an initial basic analysis, then produce a trouble ticket and forward this to the competent service engineer. This process can in some cases be supported by automatic voice devices, which deal with sub-tasks of said process, such as allocation of a caller to specific competent operators within a call center or transmission of a spoken repair order to a specific service engineer.

For practical reasons round-the-clock malfunction support is not possible or is very problematic. It is therefore desirable to make it possible to test a subscriber connection without the assistance of maintenance operators.

A system is known for this purpose from the prior art, with which a connection is set up from a subscriber connection to an automatic test device and a test on said subscriber connection is then initiated. The test result is conveyed by means of an acknowledgement tone that contains a good or bad statement. One disadvantage of this system is that the result of the test is not specified in more detail, the data is only output to the telecommunications terminal, from which the order was sent and therefore only operational subscriber connections can be tested.

The object of the invention is therefore to specify a method, which allows the operating status of a telecommunications network to be determined in a simple manner.

According to the invention this is achieved with a method of the type mentioned above,
with which the request for determination is transmitted via any telecommunications terminal to the telecommunications network,
with which based on this request the values of a plurality of predetermined operating parameters of the telecommunications network are determined,
with which an operating status is assigned to said values of the operating parameters and
with which said operating status is output in a manner that can be predetermined and that takes into account the technical knowledge of the recipient optionally to the requesting telecommunications terminal or any other.

One particular advantage of the inventive method is that it can be used by practically any subscriber in a telecommunications network, whereby however specific technical conditions of the respectively used telecommunications terminal with regard to input and output have to be taken into account.

As far as input is concerned, in other words the request to indicate the operating status, acoustic and text-based systems can be used.

An acoustic system can thereby be provided to process tones according to the Dual Tone Multifrequency Code or DTMF standard. The 12 keys of a telephone are thereby essentially available. This variant is therefore available for almost all telecommunications terminals but the user must have knowledge of the functions assigned to the individual keys. The user is therefore advantageously informed of the individual functions and the keys to be pressed for these by an automatic voice device. It is also possible for the user's voice to be converted directly to corresponding functions. It is then generally not necessary to press keys. This technology is also known as Interactive Voice Recognition or IVR.

For input in text form the Short Message Service or SMS for example can be used. Here a text message containing a request to indicate the operating status is transmitted to the telecommunications network, generally by mobile phone. In order to simplify the request for the user, a ready-made SMS containing the correct instruction can also be sent to the user's telephone.

It is also possible to use devices, which operate according to the Wireless Application Protocol or WAP standard. Here an input mask can be sent from the telecommunications network to a mobile telephone, which the user then fills in and sends back to the telecommunications network, thereby issuing the request to indicate the operating status. An appropriate standard for transmitted texts is Wireless Markup Language or WML.

It is also possible to input using devices, which are suitable for processing data according to the Hypertext Markup Language or HTML standard. Such devices include personal computers and mobile telephones, which operate according to the Universal Mobile Telephony System or UMTS standard.

The task of HTML is to describe the logical components of a document and it therefore contains commands for marking typical elements of a document, such as headings, paragraphs, lists, tables or graphic references. A further primary component of HTML is references to further documents or places within a document, known as links. HTML has become an internet standard.

The use of JAVA is also possible. JAVA is a programming language developed by Sun Microsystems that is completely platform-independent with a specific focus on internet use and with a structure and syntax based on the programming language C/C++. Java programs can be referred to in HTML files, whereby the program is loaded into the working memory of the calling computer and executed there by the Java interpreter of the WWW browser. JAVA is a standard for user-friendly internet use.

The operating status can be output both optically and acoustically. In the case of optical output, the options extend from a simple indicator lamp, through displays in text form, including comprehensive texts as well as individual words, to the use of graphic information. When the operating status is output, it is again necessary to take into account the knowledge of the addressee, so that for people familiar with a telecommunications network for example individual values can be indicated for operating parameters, while statements in purely verbal form tend to be used for people with no specific knowledge of telecommunications networks.

For example, texts in spoken form are used for acoustic output, perhaps using a text/voice converter or by outputting ready-made samples. Here an acoustic signal is scanned and the individual scan values are stored. This variant is particularly suitable for users who are less familiar with the conditions of a telecommunications network.

In principle the methods used for inputting can, as a rule, be equally applied to outputting.

Both the predetermination of the operating parameters and the assignment of an operating status can be effected using what is known as sharp or fuzzy logic. With sharp logic it is for example analyzed whether an operating parameter falls into a specific value range and the further stages of the process are derived from a true or false statement. There is no further graduation between these two statements, as is the case with fuzzy logic. Here a result can be partially true and partially false. This method is particularly suitable for statements subject to human experience values. For example the assignment of an operating status to the values of operating parameters, which are common to the person familiar with a telecommunications network, can be effected in a comparatively simple manner.

However the use of what are known as neuronal networks is also possible for the inventive method. These systems adapt their response automatically to external influences during a training phase and are very suitable for processing a wide range of information and using this information to make a statement. With the inventive method the operating parameters thereby for example form the inputs of a neuronal network and the assigned operating statuses form the outputs of said network. As with fuzzy logic an unambiguous statement is only rarely made even here. Rather the statement involves indicating the probability of the existence of a specific operating status. This method can even be used both to predetermine operating parameters and to assign an operating status.

In the context of the inventive method, telecommunications networks refer to both traditional telecommunications networks and traditional computer networks.

It is favorable,
if a data record of a database is provided as the operating parameter and/or
if an electrical parameter, in particular an electrical resistance, capacitance or inductivity, is provided as the operating parameter and/or
if a digital data transmission error rate is provided as the operating parameter.

In this way the operating parameters, which are very different in type and are often only present in a distributed manner in a telecommunications network, or only have to be determined based on a request, can advantageously be linked. For example, in the event of a request from a subscriber in a telecommunications network to determine the status of their subscriber connection, the line to their telecommunications terminal can be checked in respect of its electrical parameters, a database, in which perhaps current known malfunctions are recorded, can be scanned and the results can be linked to form a statement of the status of the subscriber connection. The database can thereby also contain information about the presumed end of a malfunction or details about the nature of the same. It is also possible to process charge-related data with a view to prioritizing malfunctions. In particular when packet-switched voice traffic is used, the data transmission error rate can be used to determine a status.

A particularly advantageous embodiment of the invention results with a method,
with which the request also comprises data provided by the user of the telecommunications terminal,
with which said data is used to predetermine the operating parameters to be determined.

This variant is particularly suitable for efficient determination of the values of predetermined operating parameters, as the scope of the operating parameters, the values of which have to be determined, can be limited based on the data from the user of the telecommunications terminal. In order to obtain easily analyzable data from the user, this can be requested interactively. The instructions and questions to the user required for this purpose can be formulated in such a way in particular for people, who have no specific knowledge of the structure of a telecommunications network and the processes operating and system statuses prevailing therein, that they can also be understood and answered even without this knowledge.

It is also advantageous,
if the request also comprises data provided by the user of the telecommunications terminal,
if said data is used in addition to the values determined for the operating parameters to assign an operating status.

The data from the user of the telecommunications terminal is used here to make a statement about the operating status in a telecommunications network, which is not based solely on the values of the operating parameters but which also includes data from the user of the telecommunications terminal. This variant of the inventive method is particularly advantageous, if the data required for assignment of an operating status cannot be obtained or can only be obtained at significant cost any other way. Here too this data can be requested interactively in order to obtain easily analyzable data from the user. When formulating the instructions and question necessary for this purpose the knowledge of the user should again be taken into account. Different formulations are also possible here for different user groups.

A method,
with which a maintenance process status is assigned to a status characterized by the values of the operating parameters,
with which the execution of at least one predetermined process stage follows this maintenance process status and
with which the maintenance process changes to a further status, is particularly advantageous.

A maintenance process status is hereby assigned to a specific status of a telecommunications network, in particular one that characterizes a malfunction. For example this status can be characterized by the information “Connection subscriber X malfunctioning because digital data transmission error rate too high”. A subsequent process stage is perhaps the generation of what is known as a “trouble ticket”, which can be compared to an electronic repair order, in some instances with a description of the malfunction, and notification of a competent engineer, possibly taking into account their current location. This notification can take place via email or using the short message service or SMS. After notification the maintenance process for example changes to a “Connection subscriber X malfunctioning, engineer notified” status. In some instances malfunctions can even be rectified fully automatically, if there are appropriate devices for this present in the telecommunications network. One possibility would be to restart a computer unit that has failed and can resume normal operation after the restart or to change the values of the operating parameters, which were identified during the test as outside the standard. A further example of a process stage is notification to the user of a defective subscriber connection after completion of the maintenance work, in particular if said user ordered the test. Said notification can be effected by setting up a connection from an automatic voice device to the subscriber, by email, SMS or similar services. The maintenance process can also include logging the malfunction rectification operation in a database. It is also possible to take into account additional charges or discounts when calculating charges, in particular as a function of the result of the test or as a function of the processes associated with the test and maintenance and stored in a database. It should be noted that the examples listed only represent a few of the many options for setting up a maintenance process and should therefore not be seen to limit the concept behind the invention.

It is also advantageous if the operating status is output in the form of an automatically created record, in particular a record in the respective national language.

In this way it is possible for a complex status of a telecommunications network, which can only be identified with difficulty by simply considering the values of the operating parameters underlying said status and can only be identified as such with corresponding technical knowledge, to be represented in a comparatively comprehensible manner. If the information contained in the record is provided appropriately, specific technical knowledge is not necessary or is necessary only to a very limited degree for the record to be understood. This variant of the invention is therefore preferably suitable for addressing subscribers in a telecommunications network directly, in other words without the intermediate involvement of appropriately trained operators. The use of this method is of course also possible for service engineers, who are then informed in a comprehensible manner about the status of a telecommunications network. This is particularly advantageous during a service engineer's induction. It is also possible to provide records of differing degrees of complexity, which are intended for the information needs of different groups of people.

The object of the invention is also achieved with an arrangement, which is prepared for the implementation of the inventive method, and
with which said arrangement comprises means for sending a request for analysis of the operating status via any telecommunications terminal,
with which means are available for determining the values of predetermined operating parameters of the telecommunications network further to this request,
with which said arrangement comprises means for assigning an operating status to said values of the operating parameters and
with which means are available to output said operating status in a predeterminable manner to any telecommunications terminal.

One particular advantage of the inventive arrangement is the possibility of using the invention in a decentralized manner, from a telecommunications terminal. This means that the service is available to practically every subscriber in a telecommunications network, whereby specific technical conditions of the respectively used telecommunications terminal in respect of input and output have to be taken into account. It should be noted that the advantages listed for the inventive method also apply equally to the inventive arrangement.

Also favorable is an arrangement,
with which means are available for assigning a status characterized by the values of the operating parameters to a maintenance process status,
with which means are available for executing at least one predetermined process stage following said maintenance process status and
with which means are available for changing the maintenance process to a further status.

Generally means for the operation of a maintenance process are already available in a telecommunications network, such as a call center for the malfunction helpdesk, in which operators responsible for maintaining a telecommunications network work together with the user of a defective subscriber connection to produce a trouble ticket and forward the repair order to a service engineer. This embodiment of the inventive arrangement discloses an advantageous option for linking a maintenance process to a system for determining the operating status of a telecommunications network.

One advantageous embodiment of the inventive arrangement results when said arrangement comprises means for displaying the operating status in the form of an automatically created record, in particular a record in the respective national language. This variant of the invention is therefore preferably suitable for addressing subscribers in a telecommunications network directly, in other words without the intermediate involvement of appropriately trained operators.

Also favorable is an arrangement, with which a telephone is provided as the telecommunications terminal, in particular a wired telephone or a mobile telephone.

It is favorable here if means are available for acoustic input and output, in particular for input and output by means of voice or DTMF tones. This means that standard telephones can be used to deploy the inventive method, which generally have the necessary technical options. For acoustic input by means of DTMF tones for example tested components can be used, which are perhaps deployed to control automatic devices in a telecommunications network. Naturally not only means for acoustic input and output are possible but also means for input and output in text form, for example via SMS, email, WAP or HTML.

It is also favorable if a personal computer is provided as the telecommunications terminal, via which input and output to and from the internet can be effected. The internet is a broad platform, to make the invention accessible to a plurality of subscribers in a telecommunications network. HTML in particular also offers an advantageous possibility for inputting or outputting information in a user-friendly manner.

The invention is described in more detail with reference to two examples shown in the FIGURE and relating to the process for determining an operating status of a telecommunications network.

The FIGURE shows a switching center VST with assigned test device TE_{VST} and assigned database DB_{VST}, a base station BS with assigned test device TE_{BS} and assigned database DB_{BS}, a base station controller BSC with assigned test device TE_{BSC} and assigned database DB_{BSC}, a mobile radio switching center MSC with assigned test device TE_{MSC} and assigned database DB_{MSC}, an automatic voice device IVR, and a test system TS with assigned database DB_{TS} and a first error processing ticket TT1. The FIGURE also shows a first user US1 with assigned computer PC_{US1}, and assigned telephone TEL_{US1}, a second user US2 with assigned computer PC_{US2}, assigned telephone TEL_{US2} and assigned mobile telephone MS_{US2}, and a third user US3 with assigned mobile telephone MS_{US3}. The FIGURE also shows a telecommunications network NET.

The telephone of the first user TEL_{US1}, and the telephone of the second user TEL_{US2} and the computer of the second user PC_{US2} are connected to the switching center VST, whereby a shared connecting line is provided for the telephone TEL_{US2} and the computer PC_{US2}. The computer of the first user PC_{US1} is connected directly to the telecommunications network NET. The mobile telephone of the second user MS_{US2} and the mobile telephone of the third user MS_{US3} are linked to the base station BS via a radio connection shown in each instance with a broken line.

The switching center VST is connected via a line to the automatic voice device IVR and via a further line to the telecommunications network NET. The automatic voice device IVR is also linked to the test system TS, which is also connected to the telecommunications network NET.

The base station BS is connected to the base station controller BSC, which is connected to the mobile radio switching center MSC. The mobile radio switching center MSC is also linked to the telecommunications network NET.

The FIGURE also shows a connection between the telephone of the first user TEL_{US1} and the test device of the switching center TE_{VST}. The mobile telephone of the second user MS_{US2} is similarly connected to the test device of the base station TE_{BS}. A connection is also shown between the telephone TEL_{US2} or the computer PC_{US2} and the automatic voice device IVR by means of a broken line.

The connections to the telephone of the first user TEL_{US1} and the mobile telephone of the second user MS_{US2} are not operational and are therefore marked with an X.

The function of the arrangement shown in the FIGURE is as follows:

In the first example it is assumed that the first user US1 ascertains that their telephone TEL_{US1} is not operational or is only operational to a limited degree. Said user cannot therefore use said device to send a request to the operator of the telephone network for information about the nature of the malfunction or to issue a repair order. They therefore establish the connection to the test system TS via their computer PC_{US1}. The test system TS provides a corresponding HTML page, which allows a test order to be sent. The first user US1 can input the call number of the subscriber connection to be tested there, in the example shown the call number of their telephone TEL_{US1}. It is also possible to request the circumstances surrounding the malfunction, as they appear to the first user US1. One example of this would be whether the voice quality of the connection is disrupted, whether links are only possible to specific connections or whether a connection cannot be switched. The list of questions to the user given here is incomplete. It is in fact possible for a great deal of information to be requested. It is assumed that the first user US1 initiates the test on their telephone TEL_{US1} without further specifying reasons, simply stating that the result should be sent by email to their computer PC_{US1}. In some instances the system should thereby ensure that the request for the listed service can only be made by authorized people, for example by inputting an ID number.

An order is then sent from the test system TS to the switching center VST, that the telephone of the first user TEL_{US1} should be checked. In the switching center VST this task is carried out using the test device TE_{VST} and the database DB_{VST}. In the example shown the electrical parameters of the line to the telephone of the first user TEL_{US1} are determined by means of the text device TE_{VST}. It is assumed that a comparatively low value results for the resistance of the a-wire to earth. In some instances the telephone TEL_{US1} can also be checked, if it has technical provision for this purpose. The database DB_{VST} also shows the module to which the telephone of the first user TEL_{US1} is assigned within the switching center VST. It is assumed that the corresponding connection module is also defective. This information is reported to the test system TS.

In the test system TS this information is analyzed using the assigned database DB_{TS}. In the example it should be recorded there that the repair work in the area of the defective trunk group has already started in the switching center. The following message is now perhaps generated via the test system TS and sent via email to the computer of the first user PC_{US1}: “We confirm receipt of your test order and regret to have to inform you that your connection with the call number x is unfortunately not operational. Maintenance work has already started and will probably be completed by y hours. This test order is free of charge”.

In the second example it is assumed that the second user US2 ascertains that their mobile telephone MS_{US2} is only operational to a limited degree, for example it is very slow when downloading data and calls are only possible to a limited degree. Said user therefore uses their telephone TEL_{US2} to dial the call number of the malfunction helpdesk and is then connected by the test system TS to the automatic voice device IVR. The automatic voice device IVR is used to request simple information from the second user US2, such as the call number of the subscriber connection to be checked. The second user US2 sends the call number of their mobile telephone MS_{US2} by means of DTMF tones and verbally adds—also at the request of the automatic voice device IVR—that if an error is identified, it is to be eliminated immediately. They also indicate that connection set-up and data transmission are only possible to a limited degree with the mobile telephone MS_{US2}. The corresponding order is prepared in the automatic voice device IVR and forwarded to the controller of the test system TS.

The test system TS is then used to send a test order to the mobile radio network, to which the mobile telephone of the second user MS_{US2} is assigned.

In the base station BS with assigned test device TE_{BS} and assigned database DB_{BS}, the base station controller BSC with assigned test device TE_{BSC} and assigned database DB_{BSC} and the mobile radio switching center MSC with assigned test device TE_{MSC} and assigned database DB_{MSC} the measurements required for the order are then carried out or the required parameters are determined. The nature of this operation is based for example on the data provided by the second user US2.

The determined data is reported to the test system TS, whereby a preliminary preparation operation can take place in the individual units. In the present example it is assumed that the cause of the error is located in a module of the base station BS. The test system TS is then used to produce an analysis of the error. The second user US2 is informed of the nature of the error during the existing connection. As said user has requested immediate error elimination, the first error elimination ticket TT₁ is produced, which is part of a maintenance process and includes the error analysis and further data relating to the malfunction. The second user US2 is informed of receipt of the repair order. The automatic voice device IVR offers the option of being notified of the end of the maintenance work, for example by callback or via email. The user selects notification by email and terminates the connection.

The first error elimination ticket TT₁ is then delivered to a competent service engineer, in the example shown the third user US3. The working hours and current locations of the operators commissioned to carry out the maintenance can for example be analyzed for this purpose, so that repair orders can be distributed as uniformly as possible. The third user US3 then starts to rectify the malfunction and forwards important developments in the maintenance process, in particular successful elimination of the error, to the test system TS. The second user US2 can therefore be kept up to date with the progress of the maintenance process. In the example shown notification about the elimination of the error is sent by email to the computer of the second user PC_{US2}.

The inventive concept is thereby not just valid for one type of communication device but can be applied to a broad technical area of telecommunications networks. Examples of these are the Plain Old Telephone System or POTS, the Integrated Services Digital Network or ISDN, the Digital Subscriber Line or DSL, the Global System for Mobile Communication or GSM, and the Universal Mobile Telephony System or UMTS.

It is also advantageous if the information associated with the malfunction can be examined. Corresponding data is for example the test results, whether the subscriber initiated the test and received notification of the successful rectification of the malfunction, a statement of costs and the necessary replacement parts, and information about the runtime from the start of the customer complaint to elimination of the problem.

If the service is used without authorization, for example if a subscriber-specific terminal is defective but the devices in the area of the operator of the telecommunications network operate correctly, a charge can be billed. The corresponding information is hereby forwarded automatically to the center responsible for billing charges.

It is also advantageous if the interfaces between the individual modules of the system are defined so that they are independent of the type of hardware used. This allows the invention to be set up on different hardware platforms. One example of a hardware-independent interface definition is the Common Object Request Broker Architecture or CORBA application.

One advantage of the invention is therefore that the subscriber in a telecommunications network can if necessary be informed immediately of the nature of the malfunction and the progress of an assigned maintenance process, as well as the automatic linking of a test order to a maintenance process.

1. A method for determining the operating status of at least one part of a telecommunications network, comprising:
transmitting a request for determination via telecommunications terminal in the telecommunications networks;
determining, based on the request, values of a plurality of predetermined operating parameters of the telecommunications networks;
assigning an operating status to the values of the operating parameters; and
outputting the operating status in a manner that can be predetermined and that takes into account technical knowledge of a recipient optionally to at least a requesting telecommunications terminal.

2. The method according to claim 1, further comprising:
providing a data record of a database as the operating parameter;
providing an electrical parameter, as the operating parameters; and
providing a digital data transmission error rate as the operating parameter.

3. The method according to claim 1, wherein
the request comprises additional data provided by a user of the telecommunications terminal, and
the data is used to predetermine the operating parameters to be determined.

4. The method according to claim 1, wherein
the request comprises data provided by a user of the telecommunications terminal, and
the data is used in addition to the values determined for the operating parameters to assign an operating status.

5. The method according to claim 1, wherein
assigning a maintenance process status to a status characterized by the values of the operating parameters,
executing at least one predetermined process stage following the maintenance process status, and
the maintenance process changes to another status.

6. The method according to claim 1, wherein the operating status is output in a form of an automatically created record.

7. An arrangement, comprising:
a first device for sending a request for analysis of an operating status via a telecommunications terminal;
a second device for determining values of predetermined operating parameters of the telecommunications network further to the request;
a third device for assigning an operating status to the values of the operating parameters; and
a fourth device for outputting the operating status in a predetermined manner to a telecommunications terminal.

8. The arrangement according to claim 7, further comprising:
fifth device for assigning a status characterized by the values of the operating parameters to a maintenance process status;
a sixth device for executing at least one predetermined process stage following the maintenance process status; and
a seventh device for changing the maintenance process to another status.

9. The arrangement according to claim 7, further comprising an eighth device for displaying the operating status in a form of an automatically created record.
